(19) United States
(12) Patent Application Publication
(10) Pub. No.: US 2026/0071411 A1
(43) Pub. Date: Mar. 12, 2026

(54) Control Method for Autonomous Working Machine, Storage Medium, and Autonomous Working Machine

(71) Applicant: POSITEC TECHNOLOGY (CHINA) CO., LTD., Suzhou (CN)

(72) Inventors: Hang YU, Suzhou (CN); Sisi YUAN, Suzhou (CN); Mingshuo HOU, Suzhou (CN); Yuanyuan WANG, Suzhou (CN); Siyuan ZHENG, Suzhou (CN); Don Zhendong Gao, Suzhou (CN)

(21) Appl. No.: 19/390,296

(22) Filed: Nov. 14, 2025

Related U.S. Application Data
(63) Continuation of application No. PCT/CN2024/093653, filed on May 16, 2024.

(30) Foreign Application Priority Data
May 16, 2023 (CN) 202310547379.7
May 27, 2023 (CN) 202310609807.4
Jul. 7, 2023 (CN) 202310833359.6

(51) Int. Cl. E02F 9/26

(52) U.S. Cl. CPC E02F 9/262; E02F 9/265

(57) ABSTRACT

A control method for an autonomous working machine, a storage medium, and an autonomous working machine are disclosed. The control method includes: when the autonomous working machine is in a boundary-following working mode and detects a first boundary and a second boundary of a working area, controlling the autonomous working machine to move based on a first direction to move along the first boundary, wherein the first boundary and the second boundary are connected and form an included angle; determining a first distance between the second boundary and the autonomous working machine; if the first distance is less than a first threshold, adjusting a pose of the autonomous working machine to increase a second distance, wherein the second distance is a distance between a rear portion of the autonomous working machine and the first boundary; and controlling the autonomous working machine to move along the second boundary.

### CROSS-REFERENCE TO RELATED APPLICATIONS

This application is a Continuation application of PCT Application No. PCT/CN2024/093653, filed on May 16, 2024, which claims benefit of and priority to Chinese Patent Application No. 202310547379.7, filed on May 16, 2023, Chinese Patent Application No. 202310609807.4, filed on May 27, 2023, Chinese Patent Application No. 202310833359.6, filed on Jul. 7, 2023, all of which are hereby incorporated by reference in their entirety for all purposes as if fully set forth herein.

### TECHNICAL FIELD

The present disclosure relates to a control method for an autonomous working machine, a storage medium, and an autonomous working machine.

### BACKGROUND

With the gradual popularization of intelligent devices in daily life, autonomous working machines (such as automatic lawn mowers for garden maintenance and floor cleaning robots for household floor cleaning) have also gained popularity among users.

Autonomous working machines typically move and/or work within a working area (such as a user's lawn) and may also move and/or work along boundaries of the working area. Taking an automatic lawn mower as an example, it can travel on a user's lawn and perform cutting operations, achieving automatic cutting of the lawn, which can significantly save manpower. When autonomous working machines are moving or working, their safety needs to be ensured to avoid damage.

### SUMMARY

To overcome the defects of the prior art, the problem to be solved by embodiments of the present disclosure is to avoid damage to the autonomous working machine while ensuring improved working coverage.

In some embodiments, a control method for an autonomous working machine is provided, the control method comprising:
in response to an operating mode of the autonomous working machine being a boundary-following working mode, and the autonomous working machine detecting a first boundary and a second boundary of a working area, controlling the autonomous working machine to move based on a first direction to move along the first boundary, wherein the first boundary and the second boundary are connected and form an included angle;
determining a first distance between the second boundary and the autonomous working machine;
in case the first distance is less than a first threshold, adjusting a pose of the autonomous working machine to increase a second distance, wherein the second distance is a distance between a rear portion of the autonomous working machine and the first boundary;
controlling the autonomous working machine to move along the second boundary.

In some embodiments, determining the first distance between the second boundary and the autonomous working machine comprises:
acquiring a first image of the working area captured by a camera of the autonomous working machine;
determining the first distance based on the first image, or generating a local map based on the first image and determining the first distance based on the local map.

In some embodiments, determining the first distance between the second boundary and the autonomous working machine comprises:
acquiring a satellite positioning signal based on a satellite positioning module of the autonomous working machine, and/or acquiring a non-contact obstacle detection signal based on a non-contact obstacle detection module of the autonomous working machine;
determining the first distance based on the satellite positioning signal and/or the non-contact obstacle detection signal.

In some embodiments, adjusting the pose of the autonomous working machine to increase the second distance comprises:
controlling the autonomous working machine to perform backward movement based on a second direction to a first pose, wherein when the autonomous working machine is at the first pose, the second distance is greater than a second threshold, the second direction has an included angle with a reverse direction of the first direction, and the second direction is a direction away from the first boundary.

In some embodiments, a backward trajectory based on the second direction is arc-shaped.

In some embodiments, after adjusting the pose of the autonomous working machine to increase the second distance and before controlling the autonomous working machine to move along the second boundary, the method further comprises:
controlling the autonomous working machine to move to a second pose, wherein when the autonomous working machine is at the second pose, a front portion of the autonomous working machine is oriented toward the second boundary, or when the autonomous working machine is at the second pose, an pose of the autonomous working machine is the same as an pose of the autonomous working machine before performing backward movement based on the second direction.

In some embodiments, controlling the autonomous working machine to move to the second pose comprises:
controlling the autonomous working machine to perform in-place rotation based on the third direction, wherein the third direction is a direction away from the first boundary.

In some embodiments, controlling the autonomous working machine to move to the second pose comprises:
controlling the autonomous working machine to perform backward movement based on a fourth direction to the second pose, wherein the fourth direction has an included angle with a reverse direction of the first direction, and the fourth direction is a direction to approach the first boundary.

In some embodiments, when the autonomous working machine is at the second pose, a distance between the autonomous working machine and the first boundary is less than the second distance.

In some embodiments, controlling the autonomous working machine to move along the second boundary comprises:
acquiring a second image captured by the camera of the autonomous working machine;
determining a boundary-following movement path corresponding to the second boundary based on the second image;
based on the boundary-following movement path, controlling the autonomous working machine to turn in a direction away from the first boundary and move along the second boundary.

In some embodiments, determining the boundary-following movement path corresponding to the second boundary based on the second image comprises:
determining a local map based on the second image;
determining the boundary-following movement path corresponding to the second boundary based on the local map.

In some embodiments, the control method further comprises:
when a distance that the autonomous working machine moves along the second boundary is greater than a third threshold, controlling the autonomous working machine to move backward;
when a distance between the autonomous working machine and the first boundary is less than a fourth threshold, controlling the autonomous working machine to move forward along the second boundary.

In some embodiments, the boundary-following working mode is an inner boundary working mode or a cross-boundary working mode; in the inner boundary working mode, the autonomous working machine performs boundary-following movement within the working area and executes vegetation maintenance; in the cross-boundary working mode, the autonomous working machine performs boundary-following movement with at least a partial structure located outside the working area and executes vegetation maintenance.

In some embodiments, the control method further comprises: in response to the operating mode being a boundary-following movement mode and the autonomous working machine detecting the first boundary and the second boundary, controlling the autonomous working machine to move along the first boundary until a distance between the autonomous working machine and the second boundary is less than a fifth threshold, wherein the fifth threshold is greater than the first threshold, and the boundary-following movement mode is that the autonomous working machine performs boundary-following movement within the working area;
controlling the autonomous working machine to turn in a direction away from the first boundary and move along the second boundary.

In some embodiments, after adjusting the pose of the autonomous working machine to increase the second distance and before controlling the autonomous working machine to move along the second boundary, the control method further comprises:
controlling the autonomous working machine to perform in-place rotation based on the third direction, wherein the third direction is a direction away from the first boundary;
controlling the autonomous working machine to move toward the second boundary;
when a distance between the autonomous working machine and the second boundary is less than a sixth threshold, controlling the autonomous working machine to move backward;
when the distance between the autonomous working machine and the second boundary is greater than a seventh threshold, controlling the autonomous working machine to turn in a direction away from the first boundary and move along the second boundary.

In some embodiments, a computer-readable storage medium is provided, wherein the storage medium stores a computer program, and the computer program is configured to execute the control method for the autonomous working machine described above.

In some embodiments, an autonomous working machine is provided, comprising:
a processor;
a memory configured to store executable instructions of the processor;
the processor configured to execute the control method for the autonomous working machine described above.

### BRIEF DESCRIPTION OF DRAWINGS

The object, technical solution, and beneficial effects of the present disclosure described above can be clearly obtained through the detailed description of specific embodiments capable of implementing the present disclosure below, combined with the description of the accompanying drawings.

The same reference numerals and symbols in the drawings and specification are used to represent the same or equivalent elements.

FIG. 1 is a structural schematic diagram of an autonomous working machine provided by some embodiments of the present disclosure;

FIG. 2 is a module schematic diagram of an autonomous working machine provided by some embodiments of the present disclosure;

FIG. 3 is a schematic diagram of a trajectory when an autonomous working machine turns directly at an inner corner;

FIG. 4 is a schematic diagram when an autonomous working machine recognizes an inner corner provided by some embodiments of the present disclosure;

FIG. 5 is a state schematic diagram of an autonomous working machine moving along a first boundary until a first distance is less than a first threshold provided by some embodiments of the present disclosure;

FIG. 6 is a schematic diagram of a first attitude of an autonomous working machine provided by some embodiments of the present disclosure

FIG. 7 is a schematic diagram of a second pose of an autonomous working machine provided by some embodiments of the present disclosure;

FIG. 8 is a schematic diagram of a trajectory and another second pose of an autonomous working machine provided by some embodiments of the present disclosure;

FIG. 9 is a schematic diagram of another trajectory of an autonomous working machine provided by some embodiments of the present disclosure;

FIG. 10 is a schematic diagram when an autonomous working machine recognizes an outer corner provided by some embodiments of the present disclosure;

FIG. 11 is a connection schematic diagram of a memory and a processor in an autonomous working machine provided by some embodiments of the present disclosure;

FIG. 12 is a flow schematic diagram of a control method for an autonomous working machine provided by some embodiments of the present disclosure;

FIG. 13 is a flow schematic diagram of determining a first distance in a control method for an autonomous working machine provided by some embodiments of the present disclosure;

FIG. 14 is another flow schematic diagram of determining a first distance in a control method for an autonomous working machine provided by some embodiments of the present disclosure.

### DETAILED DESCRIPTION

For better understanding of the present disclosure, the present disclosure will be described more comprehensively below with reference to relevant drawings. Preferred embodiments of the present disclosure are shown in the drawings. However, the present disclosure can be implemented in many different forms and is not limited to the embodiments described herein. On the contrary, these embodiments are provided to make the disclosure of the present disclosure more thorough and comprehensive in understanding. The embodiments provided in this specification can be combined with each other.

In the present disclosure, unless otherwise clearly specified and limited, terms such as “mounting”, “connecting”, “connection”, and “fixing” should be understood in a broad sense. For example, they can be fixed connection, detachable connection, or integral; they can be mechanical connection or electrical connection; they can be direct connection or indirect connection through an intermediate medium, internal communication of two elements, or interactive relationship between two elements, unless otherwise clearly limited. For those of ordinary skill in the art, the specific meanings of the above terms in the present disclosure can be understood according to specific situations.

The terms “first” and “second” are used for descriptive purposes only and cannot be understood as indicating or implying relative importance or implicitly indicating the number of the indicated technical features. Thus, features defined with “first” and “second” may explicitly or implicitly include at least one of such features. In the description of the present disclosure, “multiple” means at least two, such as two, three, etc., unless otherwise clearly and specifically limited.

Unless otherwise defined, all technical and scientific terms used herein have the same meaning as commonly understood by those skilled in the technical field of the present disclosure. The terms used in the specification of the present disclosure are only for the purpose of describing specific embodiments and are not intended to limit the present disclosure. The term “and/or” used herein includes any and all combinations of one or more related listed items.

Embodiments provide a control method for an autonomous working machine, a storage medium, and an autonomous working machine. The autonomous working machine may be an automatic lawn mower, an automatic vacuum cleaner, an automatic mopping machine, an automatic snow blower, or other intelligent devices capable of automatic movement, which can automatically move and perform corresponding work within a specified working area, and can also return to a docking station along boundaries corresponding to the working area for docking or charging.

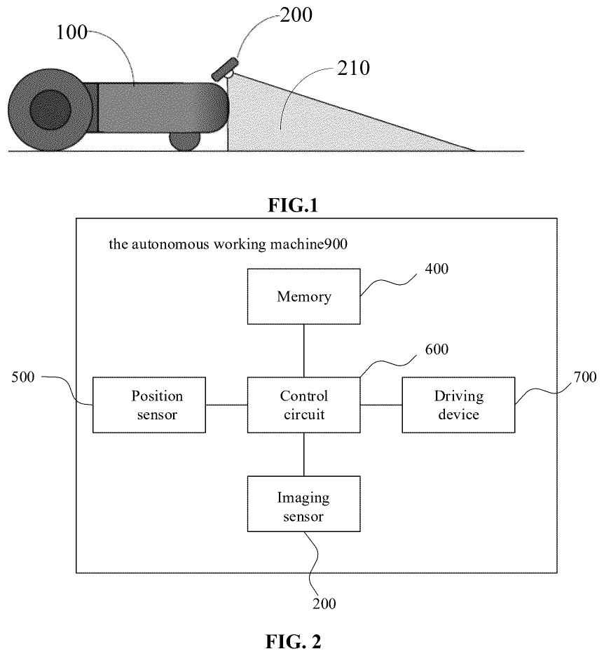

This embodiment provides an autonomous working machine. As shown in FIGS. 1 and 2, the autonomous working machine 900 includes a machine body 100, an imaging sensor 200, a position sensor 500, and a control circuit 600.

Specifically, the machine body 100 includes a driving device 700, which is configured to drive the machine body 100 to move on a working surface according to received driving instructions, and typically includes wheels and motors for driving the wheels to rotate. The wheels may include driving wheels and driven wheels. The wheels may be distributed on both sides of the machine body 100, and the number of wheels on each side may be one or two, etc.

The machine body 100 further includes a working module, which is configured to execute specific working tasks. For example, when the autonomous working machine 900 is an automatic lawn mower, the working module includes cutting blades, a cutting motor, etc., and may also include auxiliary components such as a cutting height adjustment mechanism for optimizing or adjusting the mowing effect; for example, when the autonomous working machine 900 is an automatic vacuum cleaner, the working module includes working components such as a vacuum motor, a vacuum port, a vacuum tube, a vacuum chamber, and a dust collection device for executing vacuum cleaning tasks.

The machine body 100 may further include an energy module, which is configured to provide energy for various operations of the autonomous working machine 900, and may include a rechargeable battery and a charging connection structure, wherein the charging connection structure is typically a charging electrode plate that can be used in conjunction with a charging electrode plate provided at a docking station to charge the autonomous working machine 900.

The machine body 100 further includes a memory 400, which is configured to store data generated by sensors or control circuits, or to pre-store data for use by control circuits.

The machine body 100 further includes a position sensor 500, which may include an inertial sensor IMU or an odometer ODO mounted on the driving device 700, etc., and is configured to obtain relative positions based on movement conditions of the machine body 100.

In addition to the above modules, the machine body 100 may further include a housing for accommodating and mounting various modules, a control panel for user operation, etc., and may also include various environmental sensors, such as humidity sensors, temperature sensors, acceleration sensors, light sensors, etc., wherein the sensors can assist the autonomous working machine 900 in determining the working environment to execute corresponding programs.

The control circuit 600 is a core component of the autonomous working machine 900, configured to control the autonomous working machine 900 to move and work automatically, and the functions it performs include controlling the working module to start working or stop, controlling the driving device 700 to move, determining the power level of the energy module and timely controlling the autonomous working machine 900 to return to the docking station for automatic docking and charging, executing corresponding programs in combination with data from environmental sensors, etc.

Referring to FIGS. 1 and 2, the autonomous working machine 900 includes an imaging sensor 200, which is connected to the machine body 100 and configured to capture images in a forward direction of the machine body 100, wherein the images are at least partially images of a working surface in the forward direction. The captured images are within a field of view 210 of the imaging sensor 200. The imaging sensor 200 may be a commonly used camera or lidar in the industry.

Generally, the imaging sensor 200 is mounted at an upper position at the front portion of the machine body 100, preferably centered, with a viewing angle oriented toward the front and downward to capture images of the working surface. The size of its field of view 210 can be adjusted according to actual requirements. The larger the field of view 210, the more images in the forward direction of the machine body 100 are captured, and vice versa. The forward direction of the machine body 100 can be various, such as normal forward movement, backward movement, turning, etc. In this embodiment, the forward direction of the machine body 100 refers to the direction of normal forward movement, i.e., the direction of the central axis of the machine body 100.

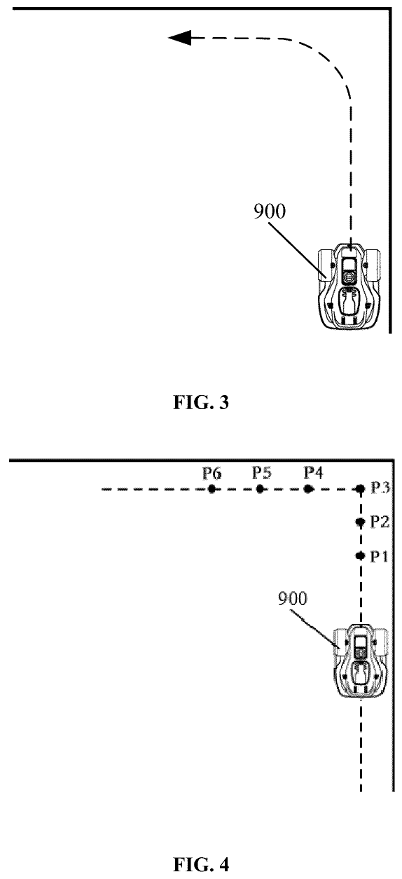

As shown in FIG. 3, in some embodiments, the working area L includes at least one sub-area, and the autonomous working machine 900 is configured to move or work within and at boundaries of the working area L; when the autonomous working machine 900 works within the working area L, it may move within the working area L and perform surface processing or vegetation maintenance; when the autonomous working machine 900 works at boundaries, it may move along boundaries of the working area L and perform surface processing or vegetation maintenance; when the autonomous working machine 900 is searching for a charging station or searching for other sub-areas from the currently located sub-area, the autonomous working machine 900 moves within the working area L or along boundaries of the working area L, without performing surface processing or vegetation maintenance while moving.

The working area L has various shapes, but since the working area L is a closed area, it necessarily forms inner corners, and the two boundaries forming an inner corner can be respectively referred to as a first boundary n1 and a second boundary n2.

Illustratively, the angle value of the corner is not limited, i.e., the first boundary n1 and the second boundary n2 can form an acute angle, an obtuse angle, or a right angle.

Illustratively, an included angle between the first boundary n1 and the second boundary n2 is less than 125°.

As shown in FIG. 3, the first boundary n1 and the second boundary n2 are connected, with an included angle between them, thereby forming an inner corner. If the autonomous working machine 900 turns directly at the corner, it cannot process or maintain the surface at the corner, resulting in reduced working coverage.

As shown in FIG. 3, taking a lawn mower as an example, when the autonomous working machine 900 encounters an inner corner, it needs to turn, but due to limited space at the inner corner, it is easy to go beyond the boundary when turning, and there may even be walls, fences, etc., at the inner corner, making collisions likely when turning; however, if the autonomous working machine 900 turns early when at a relatively far distance from the corner, although it may avoid going beyond the boundary and avoid collisions, early turning will result in grass at the inner corner not being cut, causing missed cutting and reducing cutting coverage.

To ensure improved working coverage while avoiding damage to the autonomous working machine 900, this embodiment provides a control method for the autonomous working machine 900, wherein boundaries include a first boundary n1 and a second boundary n2, with an included angle between the first boundary n1 and the second boundary n2.

As shown in FIG. 12, in some embodiments, a control method for an autonomous working machine is provided, which is applied to an autonomous working machine. The control method comprises:

Step S1: In response to an operating mode of the autonomous working machine 900 being a boundary-following working mode, and the autonomous working machine 900 detecting a first boundary n1 and a second boundary n2 of a working area L, controlling the autonomous working machine 900 to move based on a first direction to move along the first boundary n1, wherein the first boundary n1 and the second boundary n2 are connected and form an included angle.

In some embodiments, when the autonomous working machine 900 is in the boundary-following working mode, the autonomous working machine 900 maintains a certain relative positional relationship with the boundary (for example, satisfying a preset relative positional relationship with a lateral boundary), and processes or maintains the surface of the working area L on and/or near the boundary.

In some embodiments, the boundary-following working mode means that the autonomous working machine 900 moves and works on the inner side of the boundary, or the autonomous working machine 900 moves and works with at least a part of the machine body 100 extending beyond the boundary.

In some embodiments of the present disclosure, when the autonomous working machine 900 is in the boundary-following working mode, if a corner is detected, i.e., the machine detects the connected first boundary n1 and second boundary n2 (detecting that the first boundary n1 appears on the side of the machine and the second boundary n2 appears in front of the machine), and an included angle between the first boundary n1 and the second boundary n2 is less than an angle threshold (for example, 125 degrees), the autonomous working machine 900 executes an inner corner control strategy to process or maintain the surface at the inner corner. The angle threshold can be adjusted according to actual needs.

In the inner corner control strategy, the machine is first controlled to continue moving along the boundary (first boundary n1) located on the side of the machine's current position. Illustratively, a first direction is planned based on the first boundary n1, and the machine is controlled to move along the first direction to move along the first boundary n1.

Step S2: Determining a first distance between the second boundary n2 and the autonomous working machine 900.

The autonomous working machine 900 is equipped with sensors, and the machine detects the first distance between the second boundary n2 and the autonomous working machine 900 based on the sensors. The sensors include contact sensors and/or non-contact sensors. Illustratively, the sensors include one or more of a camera, an ultrasonic ranging sensor, and a satellite positioning sensor.

Step S3: In case the first distance is less than a first threshold, adjusting a pose of the autonomous working machine 900 to increase a second distance, wherein the second distance is a distance between a rear portion of the autonomous working machine 900 and the first boundary n1.

The autonomous working machine 900 moves and works along the first boundary n1 until the first distance of the autonomous working machine 900 is less than the first threshold, whereby the autonomous working machine 900 can move to a position very close to the front boundary (second boundary n2), thereby working on the corner of the inner corner; taking a lawn mower as an example, grass at the inner corner can be cut to avoid leaving grass and improve cutting coverage.

When the first distance is less than the first threshold, the autonomous working machine 900 adjusts its pose by changing the moving direction, thereby increasing the distance between its rear portion and the first boundary n1.

The autonomous working machine 900 can detect the first distance between the machine body 100 and the second boundary n2 based on sensor information, and when the first distance is less than the first threshold, can control the autonomous working machine 900 to stop moving forward. The first threshold can be set according to actual requirements. The first threshold can be a static parameter set at the factory, a static parameter adjusted by the user, or a dynamic parameter automatically adjusted by the machine. Illustratively, the sensor information can be image information, positioning information, radar information, etc. Illustratively, the first threshold is 0.2 meters.

Step S5: Controlling the autonomous working machine 900 to move along the second boundary n2.

Controlling the autonomous working machine 900 to turn toward the direction where the second boundary n2 is located and move along the second boundary n2, wherein turning can be performed in place or during movement. Since in step S3, the autonomous working machine 900 increased the distance between its rear portion and the first boundary n1, this provides greater turning space for step S5, thereby avoiding the machine from going beyond the boundary or colliding when turning in step S5, improving the operational safety of the machine.

In some embodiments, the working part of the autonomous working machine 900 is located on the right side of the autonomous machine; taking a lawn mower as an example, the cutting deck of the lawn mower is located on the right side of the lawn mower. To cut the boundary cleanly, the lawn mower executes the boundary-following working mode along the boundary in a counterclockwise direction, thereby keeping the boundary always on the right side of the lawn mower, which is favorable for the cutting deck to cut grass at the boundary.

In some embodiments, the working part of the autonomous working machine 900 is located on the left side of the autonomous machine; taking a lawn mower as an example, the cutting deck of the lawn mower is located on the left side of the lawn mower. To cut the boundary cleanly, the lawn mower executes the boundary-following working mode along the boundary in a clockwise direction, thereby keeping the boundary always on the left side of the lawn mower, which is favorable for the cutting deck to cut grass at the boundary.

When the autonomous working machine 900 moves along the boundary counterclockwise, the first boundary n1 is located on the right side of the autonomous working machine 900; when the autonomous working machine 900 moves along the boundary clockwise, the first boundary n1 is located on the left side of the autonomous working machine 900.

The second boundary n2 can be located directly in front of the autonomous working machine 900, or can be located in the left front or right front.

In some embodiments, the autonomous working machine 900 is equipped with a camera, which is mounted on the front portion of the machine and configured to capture images.

Images captured by the autonomous working machine 900 can recognize inner corners of the working area L, and the angle of the inner corner can be obtained according to relevant algorithms, and when the inner corner angle satisfies a predetermined angle range (for example, less than or equal to 125 degrees), it is determined whether the front corner needs to execute the inner corner control strategy based on the distance of the autonomous working machine 900 from the front corner.

As shown in FIG. 4, the autonomous working machine 900 can generate a local map based on multiple images, and based on the local map, obtain discrete points P1, P2, P3, P4, P5, P6 that satisfy a predetermined distance relationship with the boundary. Connecting these discrete points in sequence forms a path of the autonomous working machine 900 (shown by dotted lines). In the process of recognizing inner corners, groups of every 3 points can first be taken to determine the included angle formed by the connecting lines of the 3 points. When it is found that a group of three points has connecting lines that satisfy a predetermined angle range (for example, less than or equal to 125 degrees), groups of 5 points are selected to again determine the included angle formed by the connecting lines. Illustratively, when points P1, P2, P3 form a group, the three are on a straight line, which is not a corner position. When points P2, P3, P4 form a group, the connecting line of P2 and P3 and the connecting line of P3 and P4 form a 90-degree angle, which satisfies the angle range, but at this time, points P1, P2, P3, P4, P5 need to be taken as a group again, and the angle formed by the connecting line of P1 and P3 and the connecting line of P3 and P5 is continued to be determined. Since it is 90 degrees at this time, it still satisfies the angle range, thereby confirming that point P3 is a corner point for indicating the inner corner position of the working area L. After confirming the corner point, it can be continued to determine whether the distance of the autonomous working machine 900 from the corner point P3 is less than the first threshold. If the determination result is yes, the pose of the autonomous working machine 900 is adjusted to increase the second distance.

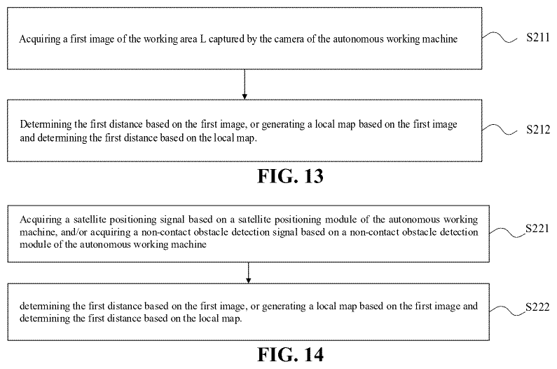

As shown in FIG. 13, in some embodiments, step S2 comprises:
Step S211: Acquiring a first image of the working area L captured by the camera of the autonomous working machine 900;
Step S212: Determining the first distance based on the first image, or generating a local map based on the first image and determining the first distance based on the local map.

The autonomous working machine 900 performs recognition processing on the first image, determines the relative positional relationship between the boundary and the machine in the first image, and obtains the first distance. The method of determining the first distance based on images is relatively accurate.

Alternatively, the autonomous working machine 900 performs steps such as image recognition and coordinate conversion on the first image and multiple historical images to obtain a local map through fusion. The local map represents the environment within a certain range around the autonomous working machine 900. The information of the local map is more abundant and can obtain a more accurate first distance.

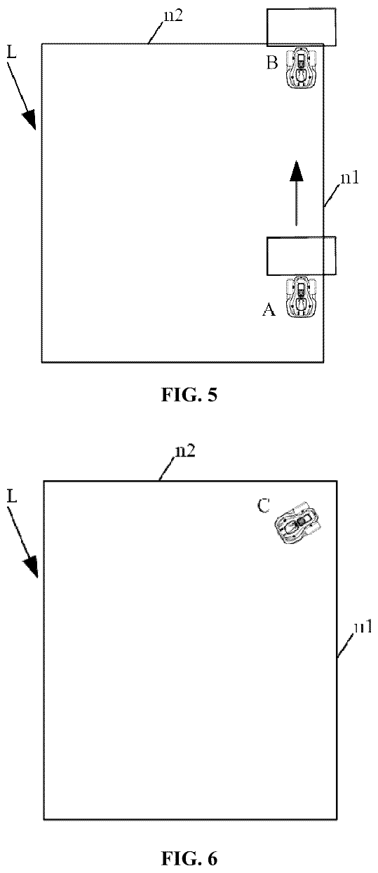

As shown in FIG. 5, in some embodiments, the autonomous working machine 900 is a front-drive machine, a camera (not shown in the figure) is provided at the front portion of the autonomous working machine 900, and the autonomous working machine 900 performs counterclockwise boundary-following movement; the autonomous working machine 900 can move and/or work along boundaries of the working area L, wherein the boundaries include a first boundary n1 and a second boundary n2, and an inner corner is formed between the first boundary n1 and the second boundary n2, with the angle of the inner corner being approximately 90°; at pose A, the image can capture the first boundary n1, the first boundary n1 is located on the right side of the machine, and the autonomous working machine 900 can process the image and determine the first direction to move forward along the first boundary n1; during the forward movement, the autonomous working machine 900 gradually approaches the second boundary n2, and the camera can gradually capture the second boundary n2; in this embodiment, the first distance between the second boundary n2 and the autonomous working machine 900 can be determined based on the image; if the first distance is large, the machine continues to move along the first boundary n1; if the first distance is less than the first threshold, the machine can adjust its pose to make the rear portion of the autonomous working machine 900 move away from the first boundary n1, increasing the distance between the rear portion of the autonomous working machine 900 and the first boundary n1, thereby creating space for subsequent turning movement and avoiding the machine from going out of bounds or colliding with the first boundary n1. In this embodiment, the pose of the autonomous working machine 900 is controlled only when the first distance is less than the first threshold, which can cut grass near corners cleanly and improve cutting coverage.

In some embodiments, the autonomous working machine 900 is equipped with a satellite positioning module and/or a non-contact obstacle detection module, wherein the satellite positioning module includes, for example, a GPS module (Global Positioning System) and an RTK module (Real-time kinematic), and the non-contact obstacle detection module includes, for example, ultrasonic sensors, radar sensors, etc. As shown in FIG. 14, step S2 comprises:
Step S221: Acquiring a satellite positioning signal based on a satellite positioning module of the autonomous working machine 900, and/or acquiring a non-contact obstacle detection signal based on a non-contact obstacle detection module of the autonomous working machine 900;
Step S222: Determining the first distance based on the satellite positioning signal and/or the non-contact obstacle detection signal.

In some embodiments, the autonomous working machine 900 pre-stores a global map of the working area L, and based on the map and the satellite positioning signal, it can determine whether the machine is currently located at a corner and the first distance between the machine and the second boundary n2.

In some embodiments, fences, barriers, or walls are provided at the boundaries, and the autonomous working machine 900 can detect the fences, barriers, or walls based on the non-contact obstacle detection module to determine the first distance.

In some embodiments, adjusting the pose of the autonomous working machine 900 to increase the second distance in step S3 comprises:
controlling the autonomous working machine 900 to perform backward movement based on a second direction to a first pose C, wherein when the autonomous working machine 900 is at the first pose C, the second distance is greater than a second threshold, the second direction has an included angle with a reverse direction of the first direction, and the second direction is a direction away from the first boundary n1.

Adjusting the pose of the autonomous working machine 900 includes controlling position and/or pose. As shown in FIGS. 5 and 6, at pose B, the autonomous working machine 900 can start adjusting its pose and can move backward based on the second direction, wherein the second direction has an included angle with the reverse direction of the first direction, the included angle can be an acute angle, and the second direction can be a direction away from the first boundary n1; illustratively, the left driving wheel of the autonomous working machine 900 can be controlled to remain stationary, and the right driving wheel can be controlled to rotate backward, thereby controlling the autonomous working machine 900 to move backward along an arc-shaped trajectory to the first pose C, so that there is sufficient distance between the rear portion of the autonomous working machine 900 and the first boundary n1, providing adequate space for subsequent turning and avoiding the autonomous working machine 900 from going out of bounds or colliding. Since the autonomous working machine 900 in FIGS. 3 and 4 performs counterclockwise boundary-following movement, the autonomous working machine 900 starts from pose B and performs arc movement toward the left rear, moving to the first pose C. In the case of clockwise boundary-following movement, the specific movement direction can be adjusted according to actual conditions.

In this embodiment, the specific angle and movement distance of the second direction can be determined based on real-time images, or the specific angle and movement distance of the second direction can be determined based on preset angles.

In some embodiments, a backward trajectory based on the second direction is arc-shaped, making the operating trajectory of the autonomous working machine 900 smoother and more aesthetically pleasing.

In some embodiments, the backward trajectory based on the second direction includes multiple sub-trajectories, that is, the autonomous working machine 900 completes step S3 through multiple short-distance backward movements.

In some embodiments, after reaching pose B, the autonomous working machine 900 can first move backward along the first boundary n1, then move forward toward the left front, thereby completing step S3.

In some embodiments, after reaching pose B, the autonomous working machine 900 is controlled to move in a direction away from both the first boundary n1 and the second boundary n2 until the movement duration is greater than a time threshold or until the movement distance is greater than a distance threshold, thereby completing step S3.

In some embodiments, after step S3 and before step S5, the method further comprises:
Step S4: Controlling the autonomous working machine 900 to move to a second pose, wherein when the autonomous working machine 900 is at the second pose, a front portion of the autonomous working machine 900 is oriented toward the second boundary n2, or when the autonomous working machine 900 is at the second pose, an pose of the autonomous working machine 900 is the same as an pose of the autonomous working machine 900 before performing backward movement based on the second direction.

In step S4, the autonomous working machine 900 adjusts its pose for the purpose of straightening the machine body 100, making the front portion of the machine body 100 oriented toward the second boundary n2, with the machine body 100 substantially perpendicular to the second boundary n2, or straightening the machine body 100 so that the pose of the machine is the same as the pose before performing backward movement based on the second direction, ensuring that the machine's subsequent forward direction is substantially parallel to the direction in step S1, which is beneficial for working on the inner corner in step S5.

In some embodiments, controlling the autonomous working machine 900 to move to the second pose in step S4 comprises:
controlling the autonomous working machine 900 to perform in-place rotation based on a third direction, wherein the third direction is a direction away from the first boundary n1.

In step S4, the method for the autonomous working machine 900 to adjust its pose can be performing in-place rotation, swinging the front portion of the machine in a direction away from the first boundary n1. In a front-drive machine, the machine body 100 can be straightened by controlling the front driving wheels of the machine to rotate.

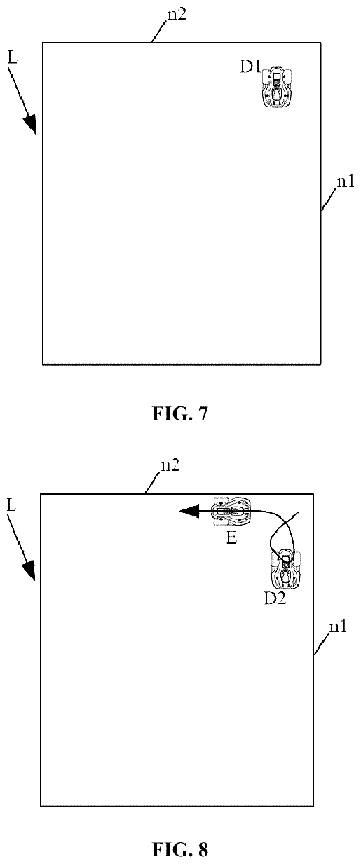

As shown in FIG. 7, at the first pose C, the autonomous working machine 900 can perform in-place rotation to the second pose D1, thereby orienting the front portion of the machine toward the second boundary n2; the rear portion of the machine gradually approaches the first boundary n1 during this process, but will not go out of bounds or collide with the first boundary n1, and the rear portion of the machine still maintains a certain distance from the first boundary n1.

If the autonomous working machine 900 performs counterclockwise boundary-following movement, the autonomous working machine 900 needs to start from the first pose C and perform in-place rotation toward the left front, rotating to the second pose D1.

In this embodiment, the specific angle and movement distance of the third direction can be determined based on real-time images, or the specific angle and movement distance of the third direction can be determined based on preset angles.

In some embodiments, controlling the autonomous working machine 900 to move to the second pose in step S4 comprises:
controlling the autonomous working machine 900 to perform backward movement based on a fourth direction to the second pose D2, wherein the fourth direction has an included angle with a reverse direction of the first direction, and the fourth direction is a direction to approach the first boundary n1.

In step S4, the method for the autonomous working machine 900 to adjust its pose can also be straightening during backward movement. In a front-drive machine, the machine body 100 can be straightened by controlling the front driving wheels of the machine to move backward while fine-tuning the direction during the backward movement.

As shown in FIG. 8, at the first pose C, the autonomous working machine 900 can move backward based on the fourth direction, thereby fine-tuning the direction during the backward movement, thus controlling the autonomous working machine 900 to move to the second pose D2; the rear portion of the machine gradually approaches the first boundary n1 during this process, but will not go out of bounds or collide with the first boundary n1, and the rear portion of the machine still maintains a certain distance from the first boundary n1.

Illustratively, the trajectory of backward movement based on the fourth direction can be arc-shaped, and arc-shaped backward movement based on the fourth direction can be achieved by controlling two driving wheels to perform differential rotation.

As shown in FIGS. 6 and 8, under the premise that the autonomous working machine 900 performs counterclockwise boundary-following movement, the autonomous working machine 900 starts from the first pose C and performs arc-shaped backward movement toward the right rear, moving to the second pose D2, with an aesthetically pleasing and smooth trajectory. Starting from pose B, the movement trajectory of the autonomous working machine 900 is as shown in FIG. 8.

In this embodiment, the specific angle and movement distance of the fourth direction can be determined based on inertial navigation data, or the specific angle and movement distance of the fourth direction can be determined based on preset angles.

In some embodiments, when the autonomous working machine 900 is at the second pose D2, a distance between the autonomous working machine 900 and the first boundary n1 is less than the second distance.

Compared to after executing step S3, the distance between the autonomous working machine 900 and the first boundary n1 after executing step S4 is smaller. With the machine in this pose executing step S5, the machine can get closer to the inner corner in step S5, improving the working coverage at the inner corner.

Throughout the entire process, at least one wheel of the autonomous working machine is rotating, making the machine's movement trajectory more aesthetically pleasing and smooth.

In some embodiments, the autonomous working machine 900 is equipped with a camera configured to capture images of the working area L;

Step S5 comprises:
acquiring a second image captured by the camera of the autonomous working machine 900;
determining a boundary-following movement path corresponding to the second boundary n2 based on the second image;
based on the boundary-following movement path, controlling the autonomous working machine 900 to turn in a direction away from the first boundary n1 and move along the second boundary n2.

In this embodiment, after the autonomous working machine 900 rotates to the second pose, it can determine the next movement direction and movement angle based on real-time images, thereby moving toward the second boundary n2, making the second boundary n2 located on its right side (such as pose E), and the autonomous working machine 900 can continue to move and/or work along the second boundary n2.

In some embodiments, determining the boundary-following movement path corresponding to the second boundary n2 based on the second image comprises:
determining a local map based on the second image;
determining the boundary-following movement path corresponding to the second boundary n2 based on the local map.

In this embodiment, a local map can be established based on real-time images and/or historical images. Illustratively, a local map can be established based on all or part of the images captured from pose B to the second pose D1 or D2, ensuring accurate map information. Path planning can be performed based on the accurate local map to determine the direction and angle of movement, obtaining a more accurate boundary-following movement path and avoiding going out of bounds or colliding during the movement process.

The machine can recognize grass, boundaries, and obstacles based on images, and mark grass, boundaries, and obstacles in the local map. Movement paths are planned based on the position information of grass, boundaries, and obstacles in the local map to avoid collision between the rear portion of the machine and obstacles during the turning process.

In some embodiments, after step S5, the control method further comprises:
when a distance that the autonomous working machine 900 moves along the second boundary n2 is greater than a third threshold, controlling the autonomous working machine 900 to move backward;
when a distance between the autonomous working machine 900 and the first boundary n1 is less than a fourth threshold, controlling the autonomous working machine 900 to move forward along the second boundary n2.

Taking a lawn mower as an example, after the lawn mower cuts the inner corner, it moves along the second boundary n2; to further ensure that grass near the inner corner is cut cleanly, it can move backward and cut after moving a certain distance along the second boundary n2, thereby performing supplementary cutting of grass near the inner corner, and then move forward and cut along the second boundary n2.

In some embodiments, the boundary-following working mode is an inner boundary working mode or a cross-boundary working mode; in the inner boundary working mode, the autonomous working machine 900 performs boundary-following movement within the working area L and executes vegetation maintenance; in the cross-boundary working mode, the autonomous working machine 900 performs boundary-following movement with at least a partial structure located outside the working area L and executes vegetation maintenance.

In the inner boundary working mode, when the autonomous working machine 900 moves along boundaries and works, the machine body 100 is always located within the working area L and will not exceed the boundaries.

In the cross-boundary working mode, when the autonomous working machine 900 moves along boundaries and works, at least a part of the machine body 100 may exceed the boundaries when the boundaries are safe, wherein boundary safety means that there are no objects such as walls or ditches around the boundaries that could easily cause machine damage.

In the inner boundary working mode, the actual position of the boundary can be determined based on images, and the autonomous working machine 900 can be controlled based on the actual position of the boundary, thereby achieving inner boundary movement. In the cross-boundary working mode, after determining the actual position of the boundary based on images, outward expansion processing is performed based on the actual position of the boundary toward the outside of the working area L to obtain an expanded boundary position, and the autonomous working machine 900 is controlled based on the expanded boundary position, thereby achieving cross-boundary movement.

In both the cross-boundary working mode and the inner boundary working mode, the machine executes the same inner corner control strategy. The difference is only that in the inner boundary working mode, the autonomous working machine 900 is controlled based on the actual position of the boundary, while in the cross-boundary working mode, the autonomous working machine 900 is controlled based on the expanded boundary position.

In some embodiments, after adjusting the pose of the autonomous working machine 900 to increase the second distance and before controlling the autonomous working machine 900 to move along the second boundary n2, the control method comprises:
controlling the autonomous working machine to perform in-place rotation based on a third direction, wherein the third direction is a direction away from the first boundary;
controlling the autonomous working machine 900 to move toward the second boundary n2;
when the distance between the autonomous working machine 900 and the second boundary n2 is less than a sixth threshold, controlling the autonomous working machine 900 to move backward;
when the distance between the autonomous working machine 900 and the second boundary n2 is greater than a seventh threshold, controlling the autonomous working machine 900 to turn in a direction away from the first boundary n1 and move along the second boundary n2.

Controlling the autonomous working machine 900 to move toward the second boundary n2, wherein the movement path has a certain distance from the movement path in step S1, and the directions of the two can be parallel or form a certain included angle. Working while moving toward the second boundary n2 can continue to cut grass near the inner corner, avoiding missed cutting.

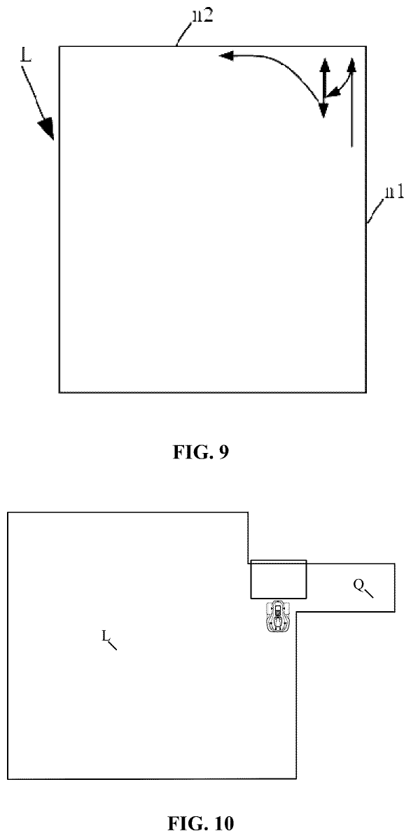

As shown in FIG. 9, the movement trajectory of the autonomous working machine 900 starting from pose A is shown in FIG. 9. First, it moves forward toward the second boundary n2 and cuts, then moves backward to the left rear, rotates to straighten the machine body 100, moves forward, moves backward (to avoid going out of bounds or colliding during subsequent turning), turns and moves to move along the second boundary n2. By moving forward toward the second boundary n2 multiple times, grass at the corner can be cut cleanly, avoiding missed cutting.

In some embodiments, if it is desired to pass through the inner corner conveniently and quickly, after executing step S1 and step S2, when the first distance is less than the first threshold, the autonomous working machine 900 can be controlled to move backward, and after moving backward for a certain distance, the autonomous working machine 900 can be controlled to turn and move along the second boundary n2. This path is beneficial for improving the working efficiency of the autonomous working machine 900.

In some embodiments, the control method further comprises: in response to the operating mode being a boundary-following movement mode and the autonomous working machine 900 detecting the first boundary n1 and the second boundary n2, controlling the autonomous working machine 900 to move along the first boundary n1 until a distance between the autonomous working machine 900 and the second boundary n2 is less than a fifth threshold, wherein the fifth threshold is greater than the first threshold, and the boundary-following movement mode is that the autonomous working machine 900 performs boundary-following movement within the working area L;
controlling the autonomous working machine 900 to turn in a direction away from the first boundary n1 and move along the second boundary n2.

In the boundary-following movement mode, the autonomous working machine 900 can move along boundaries but does not work. In this mode, there is no need to consider the issue of working coverage, so if the machine encounters an outer corner, it can turn at a position slightly farther from the first boundary n1, ensuring that it will not exceed the boundary or collide, improving the safety of the machine. The boundary-following movement mode can occur in scenarios of searching for charging stations or cross-area transition points.

In the above embodiments, each threshold can be designed according to actual requirements.

In the above embodiments, the control method can be executed by a controller of the autonomous working machine 900, and the controller can be set within the autonomous working machine 900, or can be set on a cloud server or a mobile electronic device at the user end.

In some embodiments, since the autonomous working machine 900 is relatively close to the edge when working at inner corners, it is prone to exceeding boundaries or colliding with obstacles near the boundaries when turning or moving backward. Therefore, the output torque and/or driving current of the driving component can be monitored during movement to promptly react when the autonomous working machine 900 collides, thereby reducing the probability of danger and also helping to extend the lifespan of the autonomous working machine 900.

As shown in FIG. 10, a narrow area Q is provided in the working area L in the figure. In some sites, boundaries near outer corners may be formed by walls. When a self-moving robot moves along lateral boundaries and reaches the narrow area Q, the lateral boundary will suddenly disappear in images captured by the robot, and there will be a front boundary in the images; this is because the wall at the outer corner blocks the machine's line of sight, causing the machine to be unable to see the boundary within the narrow area Q. At this time, if movement is controlled based on the front boundary, the self-moving robot will move toward the front boundary, resulting in inability to move to the narrow area Q and inability to cut the narrow area Q, causing missed grass.

To solve the technical problem of being unable to cut the narrow area Q, in some embodiments, a control method for an autonomous working machine 900 is provided, wherein the autonomous working machine 900 is configured to at least move and/or work along boundaries of a working area L, and the control method comprises:
acquiring an image of the working area L;
detecting boundaries of the working area L based on the image to determine a detection result;
in case the detection result is that a lateral boundary is detected to disappear or be interrupted, controlling the autonomous working machine 900 to continue moving along a current movement path for a certain distance and then turn toward a direction where the lateral boundary was located before disappearing or being interrupted, wherein the current movement path is a movement path of the autonomous working machine 900 before the lateral boundary disappeared or was interrupted, and the lateral boundary is a boundary of the working area L located on a side of the autonomous working machine 900.

In some embodiments, after the autonomous working machine 900 continues moving along the current movement path for a certain distance and then turns toward the direction where the lateral boundary was located before disappearing or being interrupted, the method comprises: after the autonomous working machine 900 moves along the current movement path for a first preset distance, turning toward the direction where the lateral boundary was located before disappearing or being interrupted.

In some embodiments, the control method further comprises: after the autonomous working machine 900 turns toward the direction where the lateral boundary was located before disappearing or being interrupted, re-detecting the lateral boundary and controlling the autonomous working machine 900 to move and/or work along the re-detected lateral boundary.

As shown in FIG. 10, when the autonomous working machine 900 detects that the lateral boundary disappears or is interrupted, it turns right by 90 degrees and detects boundaries based on real-time images, moving according to the boundary of the narrow area Q.

In some embodiments, the autonomous working machine 900 turning toward the direction where the lateral boundary was located before disappearing or being interrupted comprises: the autonomous working machine 900 turning in place or turning while moving, wherein in-place turning means that the rotation center of the autonomous working machine 900 does not change during turning.

In some embodiments, the autonomous working machine 900 turning in place comprises: wheels of the autonomous working machine 900 close to the lateral boundary rotating backward, and wheels far from the lateral boundary rotating forward.

Throughout the entire outer corner movement process, the wheels of the autonomous working machine 900 continuously rotate, with smooth and aesthetically pleasing movements.

In some embodiments, the control method further comprises: in case the detection result is that a lateral boundary is detected, determining a lateral boundary angle of the lateral boundary based on the image, determining a boundary-following turning direction and a boundary-following turning angle based on the lateral boundary angle; controlling the autonomous working machine 900 to move and/or work based on the boundary-following turning direction and the boundary-following turning angle.

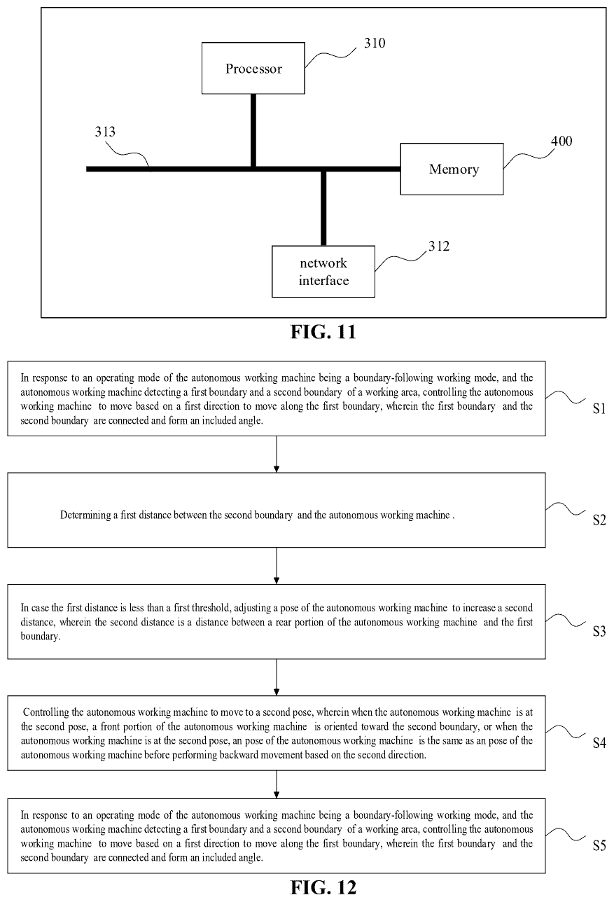

Based on the same inventive concept as the foregoing embodiments, embodiments of the present disclosure provide an autonomous working machine. As shown in FIG. 11, the autonomous working machine comprises: a processor 310 and a memory 400 storing a computer program; wherein the processor 310 shown in FIG. 11 is not used to indicate that the number of processors 310 is one, but is only used to indicate the positional relationship of the processor 310 relative to other devices. In practical disclosures, the number of processors 310 may be one or more; similarly, the memory 400 shown in FIG. 11 has the same meaning, i.e., it is only used to indicate the positional relationship of the memory 400 relative to other devices. In practical disclosures, the number of memories 400 may be one or more. When the processor 310 runs the computer program, the control method of the above embodiments is implemented.

The autonomous working machine may further comprise: at least one network interface 312. Various components in the autonomous working machine are coupled together through a bus system 313. It can be understood that the bus system 313 is used to implement connection and communication between these components. In addition to including a data bus, the bus system 313 also includes a power bus, a control bus, and a status signal bus. However, for clarity of illustration, various buses are all labeled as the bus system 313 in FIG. 9.

The memory 400 may be volatile memory or non-volatile memory, and may also include both volatile and non-volatile memory. The non-volatile memory may be Read Only Memory (ROM), Programmable Read-Only Memory (PROM), Erasable Programmable Read-Only Memory (EPROM), Electrically Erasable Programmable Read-Only Memory (EEPROM), ferromagnetic random access memory (FRAM), Flash Memory, magnetic surface memory, optical disc, or Compact Disc Read-Only Memory (CD-ROM); the magnetic surface memory may be magnetic disk memory or magnetic tape memory. The volatile memory may be Random Access Memory (RAM), which serves as external cache. By way of illustrative but not restrictive description, many forms of RAM are available, such as Static Random Access Memory (SRAM), Synchronous Static Random Access Memory (SSRAM), Dynamic Random Access Memory (DRAM), Synchronous Dynamic Random Access Memory (SDRAM), Double Data Rate Synchronous Dynamic Random Access Memory (DDRSDRAM), Enhanced Synchronous Dynamic Random Access Memory (ESDRAM), SyncLink Dynamic Random Access Memory (SLDRAM), Direct Rambus Random Access Memory (DRRAM). The memory 400 described in embodiments of the present disclosure is intended to include but not be limited to these and any other suitable types of memory.

The memory 400 in embodiments of the present disclosure is configured to store various types of data to support operations of the autonomous working machine. Examples of such data include: any computer programs for operating on the autonomous working machine, such as operating systems and disclosure programs; contact data; phonebook data; messages; pictures; videos, etc. The operating system includes various system programs, such as framework layer, core library layer, driver layer, etc., for implementing various basic services and processing hardware-based tasks. Disclosure programs may include various disclosure programs, such as Media Player, Browser, etc., for implementing various disclosure services. Here, programs implementing the methods of embodiments of the present disclosure may be included in the disclosure programs.

Based on the same inventive concept as the foregoing embodiments, this embodiment also provides a computer storage medium storing a computer program, wherein the computer storage medium may be ferromagnetic random access memory (FRAM), Read Only Memory (ROM), Programmable Read-Only Memory (PROM), Erasable Programmable Read-Only Memory (EPROM), Electrically Erasable Programmable Read-Only Memory (EEPROM), Flash Memory, magnetic surface memory, optical disc, or Compact Disc Read-Only Memory (CD-ROM), etc.; it may also be various devices including one or any combination of the above memories, such as mobile phones, computers, tablet devices, personal digital assistants, etc. When the computer program stored in the computer storage medium is executed by a processor, the control method applied to the above autonomous working machine is implemented. For the specific step processes implemented when the computer program is executed by the processor, please refer to the descriptions of the above embodiments, which will not be repeated here.

The technical features of the above embodiments can be combined arbitrarily. To make the description concise, not all possible combinations of the technical features in the above embodiments have been described. However, as long as there is no contradiction in the combination of these technical features, they should all be considered as within the scope recorded in this specification.

In this document, the terms “include”, “comprise” or any other variants thereof are intended to cover non-exclusive inclusion, which, in addition to including the listed elements, may also include other elements not explicitly listed.

The above are only specific embodiments of the present disclosure, but the protection scope of the present disclosure is not limited thereto. Any person skilled in the art can easily conceive of changes or substitutions within the technical scope disclosed by the present disclosure, which should all be covered within the protection scope of the present disclosure. Therefore, the protection scope of the present disclosure should be subject to the protection scope of the claims.

What is claimed is:

1. A control method for an autonomous working machine (900), wherein the control method comprises:
in response to an operating mode of the autonomous working machine (900) being a boundary-following working mode, and the autonomous working machine (900) detecting a first boundary (n1) and a second boundary (n2) of a working area (L), controlling the autonomous working machine (900) to move based on a first direction to move along the first boundary (n1), wherein the first boundary (n1) and the second boundary (n2) are connected and form an included angle;
determining a first distance between the second boundary (n2) and the autonomous working machine (900);
in case the first distance is less than a first threshold, adjusting a pose of the autonomous working machine (900) to increase a second distance, wherein the second distance is a distance between a rear portion of the autonomous working machine (900) and the first boundary (n1);
controlling the autonomous working machine (900) to move along the second boundary (n2).

2. The control method for the autonomous working machine (900) according to claim 1, wherein determining the first distance between the second boundary (n2) and the autonomous working machine (900) comprises:
acquiring a first image of the working area (L) captured by a camera of the autonomous working machine (900);
determining the first distance based on the first image, or generating a local map based on the first image and determining the first distance based on the local map.

3. The control method for the autonomous working machine (900) according to claim 1, wherein
determining the first distance between the second boundary (n2) and the autonomous working machine (900) comprises:
acquiring a satellite positioning signal based on a satellite positioning module of the autonomous working machine (900), and/or acquiring a non-contact obstacle detection signal based on a non-contact obstacle detection module of the autonomous working machine (900);
determining the first distance based on the satellite positioning signal and/or the non-contact obstacle detection signal.

4. The control method for the autonomous working machine (900) according to claim 1, wherein adjusting the pose of the autonomous working machine (900) to increase the second distance comprises:
controlling the autonomous working machine (900) to perform backward movement based on a second direction to a first pose (C), wherein when the autonomous working machine (900) is at the first pose (C), the second distance is greater than a second threshold, the second direction has an included angle with a reverse direction of the first direction, and the second direction is a direction away from the first boundary (n1).

5. The control method for the autonomous working machine (900) according to claim 4, wherein a backward trajectory based on the second direction is arc-shaped.

6. The control method for the autonomous working machine (900) according to claim 4, wherein after adjusting the pose of the autonomous working machine (900) to increase the second distance and before controlling the autonomous working machine (900) to move along the second boundary (n2), the method further comprises:
controlling the autonomous working machine (900) to move to a second pose (D1, D2), wherein when the autonomous working machine (900) is at the second pose (D1, D2), a front portion of the autonomous working machine (900) is oriented toward the second boundary (n2), or when the autonomous working machine (900) is at the second pose (D1, D2), an pose of the autonomous working machine (900) is the same as an pose of the autonomous working machine (900) before performing backward movement based on the second direction.

7. The control method for the autonomous working machine (900) according to claim 6, wherein controlling the autonomous working machine (900) to move to the second pose (D1, D2) comprises:
controlling the autonomous working machine (900) to perform in-place rotation based on a third direction, wherein the third direction is a direction away from the first boundary (n1).

8. The control method for the autonomous working machine (900) according to claim 6, wherein controlling the autonomous working machine (900) to move to the second pose (D1, D2) comprises:
controlling the autonomous working machine (900) to perform backward movement based on a fourth direction to the second pose (D1, D2), wherein the fourth direction has an included angle with a reverse direction of the first direction, and the fourth direction is a direction to approach the first boundary (n1).

9. The control method for the autonomous working machine (900) according to claim 6, wherein when the autonomous working machine (900) is at the second pose (D1, D2), a distance between the autonomous working machine (900) and the first boundary (n1) is less than the second distance.

10. The control method for the autonomous working machine (900) according to claim 1, wherein controlling the autonomous working machine (900) to move along the second boundary (n2) comprises:
acquiring a second image captured by the camera of the autonomous working machine (900);
determining a boundary-following movement path corresponding to the second boundary (n2) based on the second image;
based on the boundary-following movement path, controlling the autonomous working machine (900) to turn in a direction away from the first boundary (n1) and move along the second boundary (n2).

11. The control method for the autonomous working machine (900) according to claim 10, wherein determining the boundary-following movement path corresponding to the second boundary (n2) based on the second image comprises:
determining a local map based on the second image;
determining the boundary-following movement path corresponding to the second boundary (n2) based on the local map.

12. The control method for the autonomous working machine (900) according to claim 1, wherein the control method further comprises:
when a distance that the autonomous working machine (900) moves along the second boundary (n2) is greater than a third threshold, controlling the autonomous working machine (900) to move backward;
when a distance between the autonomous working machine (900) and the first boundary (n1) is less than a fourth threshold, controlling the autonomous working machine (900) to move forward along the second boundary (n2).

13. The control method for the autonomous working machine (900) according to claim 1, wherein the boundary-following working mode is an inner boundary working mode or a cross-boundary working mode; in the inner boundary working mode, the autonomous working machine (900) performs boundary-following movement within the working area (L) and executes vegetation maintenance; in the cross-boundary working mode, the autonomous working machine (900) performs boundary-following movement with at least a partial structure located outside the working area (L) and executes vegetation maintenance.

14. The control method for the autonomous working machine (900) according to claim 1, wherein the control method further comprises: in response to the operating mode being a boundary-following movement mode and the autonomous working machine (900) detecting the first boundary (n1) and the second boundary (n2), controlling the autonomous working machine (900) to move along the first boundary (n1) until a distance between the autonomous working machine (900) and the second boundary (n2) is less than a fifth threshold, wherein the fifth threshold is greater than the first threshold, and the boundary-following movement mode is that the autonomous working machine (900) performs boundary-following movement within the working area (L);
controlling the autonomous working machine (900) to turn in a direction away from the first boundary (n1) and move along the second boundary (n2).

15. The control method for the autonomous working machine (900) according to claim 1, wherein after adjusting the pose of the autonomous working machine (900) to increase the second distance and before controlling the autonomous working machine (900) to move along the second boundary (n2), the control method further comprises:
controlling the autonomous working machine (900) to perform in-place rotation based on the third direction, wherein the third direction is a direction away from the first boundary (n1);
controlling the autonomous working machine (900) to move toward the second boundary (n2);
when a distance between the autonomous working machine (900) and the second boundary (n2) is less than a sixth threshold, controlling the autonomous working machine (900) to move backward;
when the distance between the autonomous working machine (900) and the second boundary (n2) is greater than a seventh threshold, controlling the autonomous working machine (900) to turn in a direction away from the first boundary (n1) and move along the second boundary (n2).

16. A computer-readable storage medium, wherein the storage medium stores a computer program, and the computer program is configured to execute the control method for the autonomous working machine (900) according to claim 1.

17. An autonomous working machine (900), comprising:
a processor (310);
a memory (400) configured to store executable instructions of the processor;
the processor (310) configured to execute the control method for the autonomous working machine (900) according to claim 1.
